(19) United States
(12) Patent Application Publication
(10) Pub. No.: US 2010/0026824 A1
(43) Pub. Date: Feb. 4, 2010

(54) IMAGE SENSOR WITH REDUCED RED LIGHT CROSSTALK

(76) Inventor: Shenlin Chen, Rochester, NY (US)

Correspondence Address: Pedro P. Hernandez;Patent Legal Staff, Eastman Kodak Company, 343 State Street, Rochester, NY, 14650-2201, US

(21) Appl. No.: 12/181,331

(22) Filed: Jul. 29, 2008

(51) Int. Cl. H04N 5/228; G03G 15/00

(52) U.S. Cl. 348/222.1; 399/2

(57) ABSTRACT

An image sensor having a pixel array includes a sensor layer comprising a plurality of photosensitive elements of the pixel array, a circuit layer comprising circuitry associated with the pixel array, and a crosstalk reduction layer arranged between the sensor layer and the circuit layer and configured to reduce crosstalk between adjacent ones of the photosensitive elements. The crosstalk reduction layer may comprise, for example, an amorphous silicon germanium (a-SiGe) layer specifically configured to reduce red light crosstalk in the image sensor. The image sensor may be implemented in a digital camera or other type of digital imaging device.

### FIELD OF THE INVENTION

The present invention relates generally to electronic image sensors for use in digital cameras and other types of imaging devices, and more particularly to processing techniques for use in forming image sensors.

### BACKGROUND OF THE INVENTION

A typical electronic image sensor comprises a number of light sensitive picture elements (“pixels”) arranged in a two-dimensional array. Such an image sensor may be configured to produce a color image by forming an appropriate color filter array (CFA) over the pixels. Examples of image sensors of this type are disclosed in U.S. Patent Application Publication No. 2007/0024931, entitled “Image Sensor with Improved Light Sensitivity,” which is incorporated by reference herein.

As is well known, an image sensor may be implemented using complementary metal-oxide-semiconductor (CMOS) circuitry. In such an arrangement, each pixel typically comprises a photodiode and other circuitry elements that are formed in a silicon sensor layer on a silicon substrate. One or more dielectric layers are usually formed above the silicon sensor layer and may incorporate additional circuitry elements as well as multiple levels of metallization used to form interconnects. The side of the image sensor on which the dielectric layers and associated levels of metallization are formed is commonly referred to as the frontside, while the side having the silicon substrate is referred to as the backside.

In a frontside illuminated image sensor, light from a subject scene is incident on the frontside of the image sensor, and the silicon substrate is relatively thick. However, the presence of metallization level interconnects and various other features associated with the dielectric layers on the frontside of the image sensor can adversely impact the fill factor and quantum efficiency of the image sensor.

A backside illuminated image sensor addresses the fill factor and quantum efficiency issues associated with the frontside dielectric layers by thinning or removing the thick silicon substrate and arranging the image sensor such that light from a subject scene is incident on the backside of the image sensor. Thus, the incident light is no longer impacted by metallization level interconnects and other features of the dielectric layers, and fill factor and quantum efficiency are improved.

It is also known to form a given image sensor as a so-called stacked image sensor. In a typical arrangement of this type, a sensor layer is arranged in a stack with a circuit layer. The sensor and circuit layers may be formed using separate sensor and circuit wafers, respectively. The separate wafers in which the sensor and circuit layers are formed are subsequently attached together in a stacked configuration and electrically interconnected with one another.

A given stacked image sensor arrangement may also be referred to as a sensor on top (SOT) arrangement, as the sensor layer comprising the photodiodes or other photosensitive elements of the pixel array is on the top of the image sensor stack. The sensor layer of the SOT arrangement is typically configured for backside illumination.

A problem that can arise in conventional image sensors of the type described above relates to crosstalk between adjacent photosensitive elements. More particularly, absorption in silicon of longer wavelength portions of the incident light spectrum, such as red light, is relatively low compared to that of shorter wavelength portions. As a result, charge carriers can be generated from red light at a substantial depth into the silicon sensor layer. This condition unfortunately leads to excessive red light crosstalk between adjacent photosensitive elements.

Accordingly, a need exists for an image sensor that exhibits reduced red light crosstalk.

### SUMMARY OF THE INVENTION

Illustrative embodiments of the invention provide image sensors each having a crosstalk reduction layer that may be specifically configured to reduce red light crosstalk between adjacent photosensitive elements of a pixel array. These embodiments include both backside illuminated and frontside illuminated image sensors.

In accordance with one aspect of the invention, a process of forming an image sensor is provided. The image sensor includes a sensor layer comprising a plurality of photosensitive elements of a pixel array, and a circuit layer comprising circuitry associated with the pixel array. The process includes the step of arranging a crosstalk reduction layer between the sensor layer and the circuit layer, wherein the crosstalk reduction layer is configured to reduce crosstalk between adjacent ones of the photosensitive elements.

The crosstalk reduction layer in one embodiment may comprise, for example, an amorphous silicon germanium (a-SiGe) layer specifically configured to reduce red light crosstalk in the image sensor. In other embodiments, the crosstalk reduction layer may comprise other combinations of silicon and germanium. It is also possible to use a layer comprising germanium but no silicon, or layers comprising other types of narrow bandgap materials having high defect densities. Such materials can facilitate recombination of carriers generated by red light portions of the incident light spectrum deep in the sensor layer, where such carriers would otherwise lead to the red light crosstalk problem previously described.

In accordance with another aspect of the invention, an image sensor having a pixel array includes a sensor layer comprising a plurality of photosensitive elements of the pixel array, a circuit layer comprising circuitry associated with the pixel array, and a crosstalk reduction layer arranged between the sensor layer and the circuit layer and configured to reduce crosstalk between adjacent ones of the photosensitive elements.

As indicated previously, an image sensor in accordance with the invention may be configured for either backside illumination or frontside illumination.

An image sensor in accordance with the invention may be advantageously implemented in a digital camera or other type of imaging device. The image sensor provides improved performance in such a device through a significant reduction in red light crosstalk.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of a digital camera having a backside illuminated image sensor configured in accordance with an illustrative embodiment of the invention;

FIG. 2 is a cross-sectional view showing a portion of a backside illuminated image sensor with reduced red light crosstalk in a first illustrative embodiment of the invention;

FIG. 3 is a cross-sectional view showing a portion of a backside illuminated image sensor with reduced red light crosstalk in a second illustrative embodiment of the invention; and

FIG. 4 is a plan view of an image sensor wafer comprising multiple image sensors of the type illustrated in FIG. 2 or 3.

### DETAILED DESCRIPTION OF THE INVENTION

The present invention will be illustrated herein in conjunction with particular embodiments of digital cameras, image sensors, and processing techniques for forming such image sensors. It should be understood, however, that these illustrative arrangements are presented by way of example only, and should not be viewed as limiting the scope of the invention in any way. Those skilled in the art will recognize that the disclosed arrangements can be adapted in a straightforward manner for use with a wide variety of other types of imaging devices and image sensors.

For example, although the image sensors of certain of the illustrative embodiments described herein are configured for backside illumination, other embodiments may be configured for frontside illumination, and the present invention is not limited in this regard. Also, embodiments of the invention may be implemented as stacked image sensors, SOT image sensors, or in other configurations.

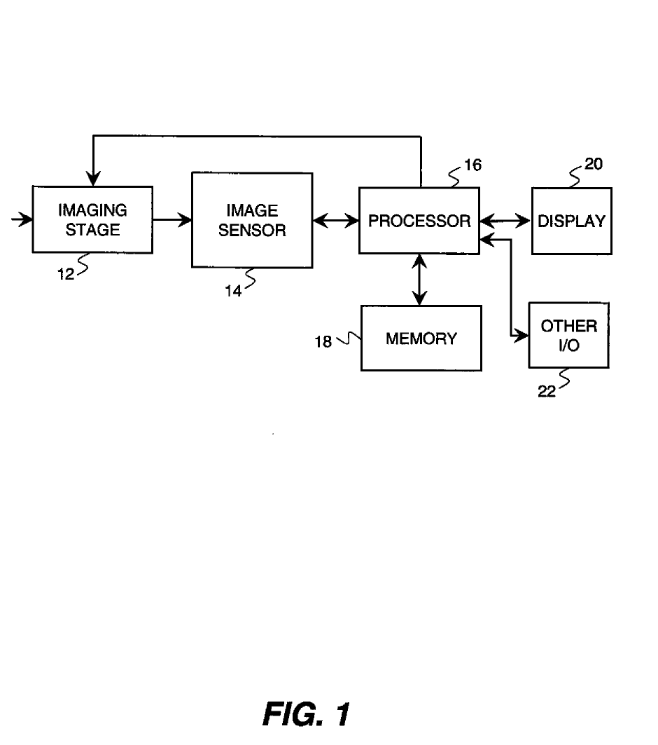

FIG. 1 shows a digital camera 10 in an illustrative embodiment of the invention. In the digital camera, light from a subject scene is input to an imaging stage 12. The imaging stage may comprise conventional elements such as a lens, a neutral density filter, an iris and a shutter. The light is focused by the imaging stage 12 to form an image on an image sensor 14, which converts the incident light to electrical signals. The digital camera 10 further includes a processor 16, a memory 18, a display 20, and one or more additional input/output (I/O) elements 22.

Although shown as separate elements in the embodiment of FIG. 1, the imaging stage 12 may be integrated with the image sensor 14, and possibly one or more additional elements of the digital camera 10, to form a compact camera module.

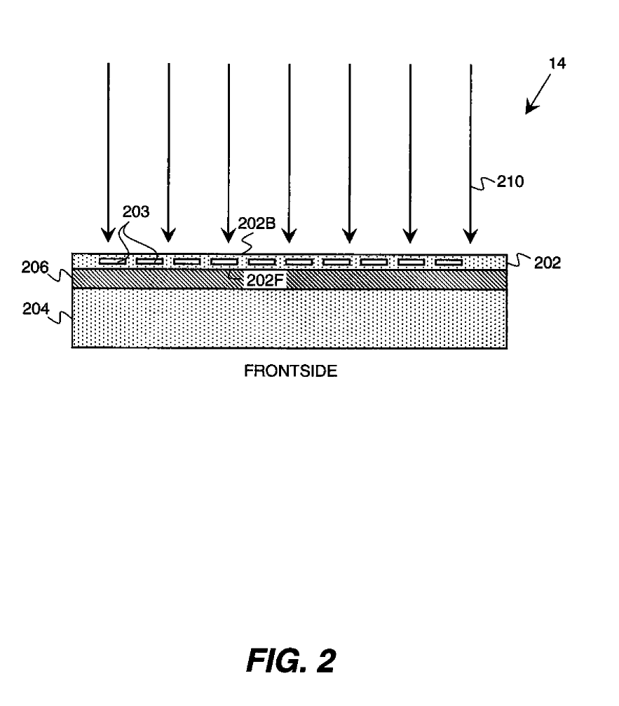

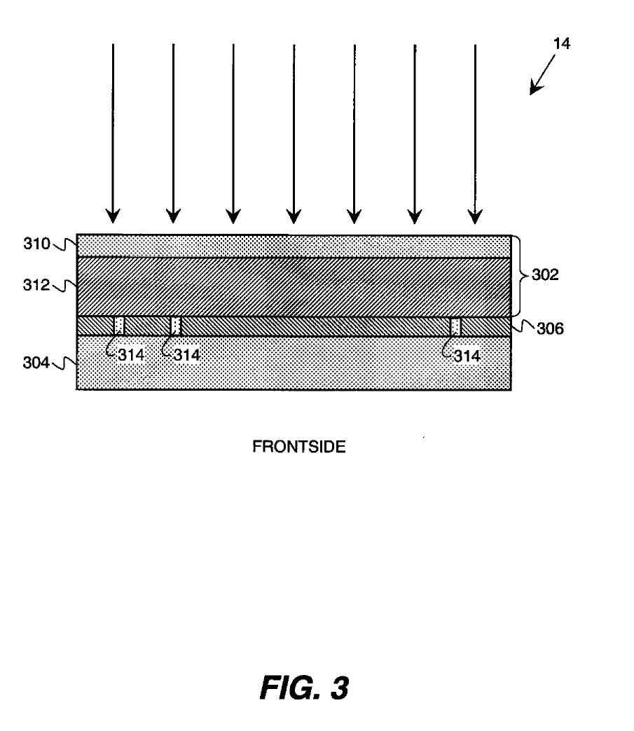

The image sensor 14 is assumed in the present embodiment to be a CMOS image sensor, although other types of image sensors may be used in implementing the invention. More particularly, the image sensor 14 in this embodiment comprises a backside illuminated image sensor that includes a crosstalk reduction layer arranged between a sensor layer and a circuit layer, as will be described below in conjunction with FIGS. 2 and 3. The image sensor generally comprises a pixel array having a plurality of pixels arranged in rows and columns and may include additional circuitry associated with sampling and readout of the pixel array, such as signal generation circuitry, signal processing circuitry, row and column selection circuitry, etc. This sampling and readout circuitry may comprise, for example, an analog signal processor for processing analog signals read out from the pixel array and an analog-to-digital converter for converting such signals to a digital form. These and other types of circuitry suitable for use in the digital camera 10 are well known to those skilled in the art and will therefore not be described in detail herein. Portions of the sampling and readout circuitry may be arranged external to the image sensor, or formed integrally with the pixel array, for example, on a common integrated circuit with photodiodes and other elements of the pixel array.

The image sensor 14 will typically be implemented as a color image sensor having an associated CFA pattern. Examples of CFA patterns that may be used with the image sensor 14 include those described in the above-cited U.S. Patent Application Publication No. 2007/0024931, although other CFA patterns may be used in other embodiments of the invention. As another example, a conventional Bayer pattern may be used, as disclosed in U.S. Pat. No. 3,971,065, entitled “Color Imaging Array,” which is incorporated by reference herein.

The processor 16 may comprise, for example, a microprocessor, a central processing unit (CPU), an application-specific integrated circuit (ASIC), a digital signal processor (DSP), or other processing device, or combinations of multiple such devices. Various elements of the imaging stage 12 and the image sensor 14 may be controlled by timing signals or other signals supplied from the processor 16.

The memory 18 may comprise any type of memory, such as, for example, random access memory (RAM), read-only memory (ROM), Flash memory, disk-based memory, removable memory, or other types of storage elements, in any combination.

Functionality associated with sampling and readout of the pixel array and the processing of corresponding image data may be implemented at least in part in the form of software that is stored in memory 18 and executed by processor 16.

A given image captured by the image sensor 14 may be stored by the processor 16 in memory 18 and presented on display 20. The display 20 is typically an active matrix color liquid crystal display (LCD), although other types of displays may be used. The additional I/O elements 22 may comprise, for example, various on-screen controls, buttons or other user interfaces, network interfaces, memory card interfaces, etc.

Additional details regarding the operation of a digital camera of the type shown in FIG. 1 can be found, for example, in the above-cited U.S. Patent Application Publication No. 2007/0024931.

It is to be appreciated that the digital camera as shown in FIG. 1 may comprise additional or alternative elements of a type known to those skilled in the art. Elements not specifically shown or described herein may be selected from those known in the art. As noted previously, the present invention may be implemented in a wide variety of other types of digital cameras or imaging devices. Also, as mentioned above, certain aspects of the embodiments described herein may be implemented at least in part in the form of software executed by one or more processing elements of an imaging device. Such software can be implemented in a straightforward manner given the teachings provided herein, as will be appreciated by those skilled in the art.

The image sensor 14 may be fabricated on a silicon substrate or other type of substrate. In a typical CMOS image sensor, each pixel of the pixel array includes a photodiode and associated circuitry for measuring the light level at that pixel. Such circuitry may comprise, for example, transfer gates, reset transistors, select transistors, output transistors, and other elements, configured in a well-known conventional manner.

As indicated above, FIGS. 2 and 3 illustrate the manner in which image sensor 14 may be configured to include a crosstalk reduction layer arranged between a sensor layer and a circuit layer in illustrative embodiments of the present invention. It should be noted that these figures are simplified in order to clearly illustrate various aspects of the present invention, and are not necessarily drawn to scale. A given embodiment may include a variety of other features or elements that are not explicitly illustrated but would be familiar to one skilled in the art as being commonly associated with image sensors of the general type described.

FIG. 2 shows image sensor 14 in a first illustrative embodiment. The image sensor 14 includes a sensor layer 202 comprising a plurality of photosensitive elements 203 of the pixel array, a circuit layer 204 comprising analog circuitry associated with the pixel array, and a crosstalk reduction layer 206 arranged between the sensor layer and the circuit layer. The photosensitive elements typically comprise photodiodes, although other types of photosensitive elements may be used. The pixel array in this example is an active pixel array, that is, a pixel array that includes active pixel circuitry in addition to the photosensitive elements 203.

Although not shown in the figure, one or more oxide layers or other insulating layers may be arranged between the sensor layer 202 and the crosstalk reduction layer 206. Such layers may comprise, for example, an interlayer dielectric (ILD) formed of oxide or other suitable insulating material. Also, the circuit layer 204 may comprise, in addition to the above-noted analog circuitry, an intermetal dielectric (IMD) that separates multiple levels of metallization. The ILD and IMD are illustrative examples of what are more generally referred to herein as dielectric layers.

The image sensor 14 in the present embodiment is a backside illuminated image sensor, in that light from a subject scene is incident on the backside of the image sensor, as indicated by the lines 210. The side opposite the backside is labeled as the frontside in the figure. The terms “frontside” and “backside” will be used herein to denote particular sides of an image sensor wafer or an image sensor formed from such a wafer, as well as sides of particular layers of the image sensor wafer or corresponding image sensor. For example, the sensor layer 202 has a frontside surface 202F and a backside surface 202B.

It should be noted that terms such as “on” or “over” when used in conjunction with layers of an image sensor wafer or corresponding image sensor are intended to be construed broadly, and therefore should not be interpreted to preclude the presence of one or more intervening layers or other intervening image sensor features or elements. Thus, a given layer that is described herein as being formed on or formed over another layer may be separated from the latter layer by one or more additional layers.

The image sensor 14 illustrated in FIG. 2 is an example of an image sensor formed from a silicon-on-insulator (SOI) wafer. Such a wafer generally comprises a silicon substrate, a buried oxide (BOX) layer formed over the substrate, and a silicon sensor layer formed over the oxide layer. The thickness of the silicon sensor layer may be approximately 1 to 6 micrometers (μm), and the thickness of the buried oxide layer may be approximately 0.1 to 0.5 μm, although other thicknesses may be used. The silicon substrate is typically substantially thicker than the sensor layer or buried oxide layer. Alternative embodiments of the invention may utilize other types of wafers to form backside illuminated image sensors, such as, for example, epitaxial wafers or bulk semiconductor wafers that do not include a buried oxide layer, although an SOI wafer generally provides a smoother surface for backside processing.

In the process of forming the image sensor 14, the substrate is typically removed, leaving the buried oxide layer and the sensor layer. Thus, although not expressly shown in FIG. 2, at least a portion of the buried oxide layer may remain on the backside surface 202B of the sensor layer 202. In other embodiments, the buried oxide layer may be removed in its entirety.

The circuit layer 204 may be formed using a separate wafer that is subsequently bonded to an SOI wafer in which the sensor layer 202 is formed.

Alternatively, a single SOI wafer or other type of wafer may be used to form both the sensor and the circuit layers.

The crosstalk reduction layer 206 in the present embodiment comprises an amorphous silicon germanium (a-SiGe) layer. This exemplary narrow bandgap material typically has a high defect density, and thus electron-hole pairs that are generated deep in the sensor layer 202 from incident red light will tend to be quickly recombined. Such recombined carriers will not contribute to charge measurements, and thus red light crosstalk between adjacent ones of the photosensitive elements 203 is reduced.

In alternative embodiments, other combinations of silicon and germanium may be used to form the crosstalk reduction layer 206, as well as other types of narrow bandgap materials having high defect densities. In this context, narrow bandgap materials are intended to encompass, without limitation, materials having bandgaps on the order of 1.3 electron volts (eV), although the particular bandgap and defect density in a given embodiment may vary depending upon application-specific factors such as deposition conditions. It is also possible that the crosstalk reduction layer may comprise only germanium, rather than a combination of silicon and germanium as in the above example. The percentage of germanium in the crosstalk reduction layer 206 in such embodiments may therefore be on the order of about 10% to 100%. Again, alternative embodiments need not utilize germanium, but could instead utilize other narrow bandgap materials.

The a-SiGe layer used for crosstalk reduction layer 206 in the present embodiment may be formed, for example, by conventional deposition techniques such as plasma chemical vapor deposition (CVD) or thermal CVD using silane gas (SiH₄). The thickness of the a-SiGe layer may be on the order of 0.1 μm to 10 μm. By way of example, this a-SiGe layer may be formed on the frontside surface 202F of the sensor layer 202 prior to attachment or formation of the circuit layer 204.

FIG. 3 shows the image sensor 14 in another illustrative embodiment. The image sensor 14 in this embodiment includes a sensor layer 302, a circuit layer 304, and a crosstalk reduction layer 306 arranged between the sensor layer and the circuit layer. The crosstalk reduction layer may comprise, for example, the a-SiGe layer as previously described in conjunction with the embodiment of FIG. 2.

The sensor layer 302 in the FIG. 3 embodiment comprises a first semiconductor layer 310 of a first conductivity type. The sensor layer 302 further comprises a second semiconductor layer 312 of a second conductivity type, arranged between the crosstalk reduction layer 306 and the first semiconductor layer 310 of the first conductivity type. The first and second semiconductor layers may comprise, for example, doped silicon layers, as will be described in greater detail below.

In one possible implementation of the sensor layer 302, the first semiconductor layer 310 comprises an N+ layer and the second semiconductor layer 312 comprises a P layer The photosensitive elements of the pixel array, which are not explicitly shown in this figure, are formed utilizing the layers 310 and 312. A number of vertical conductors 314 pass between the sensor layer 302 and the circuit layer 304 through the crosstalk reduction layer 306. These vertical conductors 314 serve to provide electrical interconnection between various elements of the sensor and circuit layers.

The dopants used to form the N+ layer are n-type dopants such as arsenic or phosphorus, at concentrations of about 1×10²⁰ to 1×10²¹ atoms/cm³. The dopants used to form the P layer are p-type dopants such as boron or indium, at concentrations of about 1×10¹⁵ to 1×10¹⁸ atoms/cm³. The thicknesses of the N+ and P layers may be on the order of about 0.5 μm to 3 μm, although other thicknesses may be used.

In an alternative implementation of the sensor layer 302, the first semiconductor layer 310 comprises a P+ layer and the second semiconductor layer 312 comprises an N layer. Again, the photosensitive elements of the pixel array, which are not explicitly shown in this figure, are formed utilizing the layers 310 and 312.

The dopants used to form the P+ layer are p-type dopants such as boron or indium, at concentrations of about 1×10²⁰ to 1×10²¹ atoms/cm³. The dopants used to form the N layer are n-type dopants such as arsenic or phosphorus, at concentrations of about 1×10¹⁵ to 1×10¹⁸ atoms/cm³. As in the previous example, the thicknesses of the P+ and N layers may be on the order of about 0.5 μm to 3 μm.

In the embodiments of FIGS. 2 and 3, the image sensor 14 is configured for backside illumination. As noted previously, alternative embodiments of the invention may include frontside illuminated image sensors having a crosstalk reduction layer arranged between sensor and circuit layers. Such image sensors can be formed in a straightforward manner utilizing the teachings provided herein.

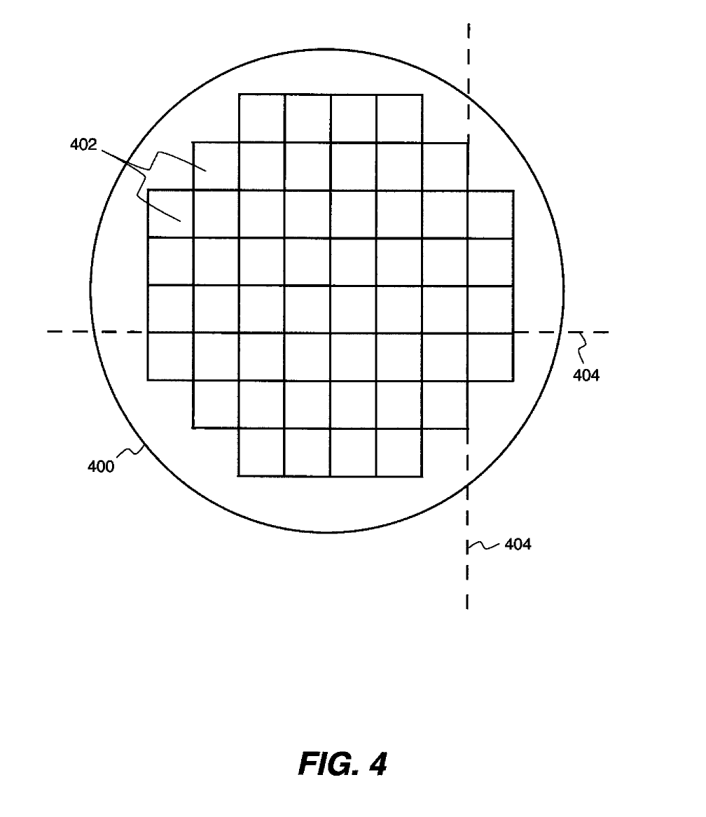

FIG. 4 shows an image sensor wafer 400 that may be used to form a plurality of image sensors of the type shown in FIG. 2 or 3. Multiple image sensors 402 are formed through wafer level processing of the image sensor wafer 400 and then separated from one another by dicing the wafer along dicing lines 404. Each of the image sensors 402 may be an image sensor 14 as illustrated in FIG. 2 or 3.

The invention has been described in detail with particular reference to certain illustrative embodiments thereof, but it will be understood that variations and modifications can be effected within the scope of the invention as set forth in the appended claims. For example, the invention can be implemented in other types of image sensors and digital imaging devices, using alternative materials, wafers, layers, process steps, etc. Thus, a given image sensor may include one or more oxide layers or other insulating layers between the sensor layer and the crosstalk reduction layer, and a single SOI wafer or other type of wafer may be used to form both the sensor layer and the circuit layer. Also, various process parameters such as layer thicknesses and dopant concentrations described in conjunction with the illustrative embodiments can be varied in alternative embodiments. These and other alternative embodiments will be readily apparent to those skilled in the art.

### PARTS LIST

10 digital camera

12 imaging stage

14 backside illuminated image sensor

16 processor

18 memory

20 display

22 input/output (I/O) elements

202 sensor layer

202B sensor layer backside surface

202F sensor layer frontside surface

203 photosensitive elements

204 circuit layer

206 crosstalk reduction layer

210 incident light

302 sensor layer

304 circuit layer

306 crosstalk reduction layer

310 first semiconductor layer

312 second semiconductor layer

314 vertical conductors

400 image sensor wafer

402 image sensors

404 dicing lines

1. A method of forming an image sensor having a pixel array, the image sensor including a sensor layer comprising a plurality of photosensitive elements of the pixel array and a circuit layer comprising circuitry associated with the pixel array, the method comprising the step of:
arranging a crosstalk reduction layer between the sensor layer and the circuit layer;
wherein the crosstalk reduction layer is configured to reduce crosstalk between adjacent ones of the photosensitive elements.

2. The method of claim 1 wherein the step of arranging the crosstalk reduction layer further comprises forming the crosstalk reduction layer as a layer comprising germanium.

3. The method of claim 2 wherein the step of arranging the crosstalk reduction layer further comprises forming the crosstalk reduction layer as a layer comprising a combination of silicon and germanium.

4. The method of claim 3 wherein step of forming the crosstalk reduction layer as a layer comprising a combination of silicon and germanium further comprises the step of forming the crosstalk reduction layer as an amorphous silicon germanium (a-SiGe) layer.

5. The method of claim 1 wherein the crosstalk reduction layer is configured to reduce red light crosstalk between adjacent ones of the photosensitive elements.

6. The method of claim 1 wherein the sensor layer comprises a first semiconductor layer of a first conductivity type.

7. The method of claim 6 wherein the sensor layer further comprises a second semiconductor layer of a second conductivity type arranged between the crosstalk reduction layer and the first semiconductor layer of the first conductivity type.

8. The method of claim 7 wherein the first semiconductor layer comprises an N+ layer and the second semiconductor layer comprises a P layer.

9. The method of claim 7 wherein the first semiconductor layer comprises a P+ layer and the second semiconductor layer comprises an N layer.

10. The method of claim 1 further comprising the step of forming a plurality of vertical conductors passing through the crosstalk reduction layer.

11. The method of claim 1 wherein the sensor layer is formed from a first semiconductor wafer and the circuit layer is formed from a second semiconductor wafer that is attached to the first semiconductor wafer.

12. An image sensor having a pixel array, the image sensor comprising:
a sensor layer comprising a plurality of photosensitive elements of the pixel array;
a circuit layer comprising circuitry associated with the pixel array; and
a crosstalk reduction layer arranged between the sensor layer and the circuit layer and configured to reduce crosstalk between adjacent ones of the photosensitive elements.

13. The image sensor of claim 12 wherein the crosstalk reduction layer comprises germanium.

14. The image sensor of claim 13 wherein the crosstalk reduction layer comprises a combination of silicon and germanium.

15. The image sensor of claim 14 wherein the crosstalk reduction layer comprises an amorphous silicon germanium (a-SiGe) layer.

16. The image sensor of claim 12 wherein the crosstalk reduction layer has a thickness of about 0.1 to 10 micrometers.

17. The image sensor of claim 12 wherein the crosstalk reduction layer comprises a material having a bandgap of approximately 1.3 electron volts.

18. The image sensor of claim 12 wherein the sensor layer comprises a first semiconductor layer of a first conductivity type, and further comprises a second semiconductor layer of a second conductivity type arranged between the crosstalk reduction layer and the first semiconductor layer of the first conductivity type.

19. A digital imaging device comprising:
an image sensor having a pixel array; and
one or more processing elements configured to process outputs of the image sensor to generate a digital image;
wherein said image sensor comprises:
a sensor layer comprising a plurality of photosensitive elements of the pixel array;
a circuit layer comprising circuitry associated with the pixel array; and
a crosstalk reduction layer arranged between the sensor layer and the circuit layer and configured to reduce crosstalk between adjacent ones of the photosensitive elements.

20. The digital imaging device of claim 19 wherein said imaging device comprises a digital camera.
